(19) United States
(12) Patent Application Publication
(10) Pub. No.: US 2026/0357150 A1
(43) Pub. Date: Nov. 12, 2026

(54) POLYPHENYL OXIDE LIQUIDS FOR LUBRICANT AND COOLANT APPLICATIONS

(71) Applicant: EXXONMOBIL TECHNOLOGY AND ENGINEERING COMPANY, Spring, TX (US)

(72) Inventors: Joseph S. BAIR, Bangor, PA (US); Zhisheng GAO, Flemington, NJ (US)

(73) Assignee: EXXONMOBIL TECHNOLOGY AND ENGINEERING COMPANY, Spring, TX (US)

(21) Appl. No.: 19/650,141

(22) Filed: Apr. 16, 2026

Related U.S. Application Data
(60) Provisional application No. 63/796,166, filed on Apr. 28, 2025.

(51) Int. Cl. C10M 169/04; C09K 5/08; C10N 30/02

(52) U.S. Cl. CPC C10M 169/045; C09K 5/08; C10M 2207/04; C10N 2030/02

(57) ABSTRACT

In some aspects, the present disclosure relates to a compound having the structure

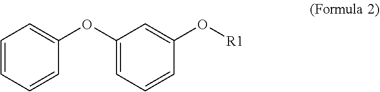

wherein R1 is either

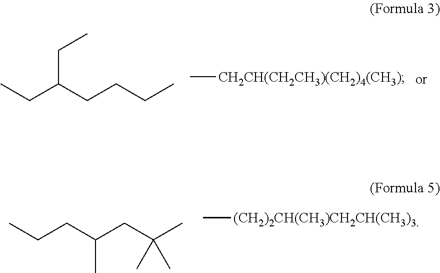

Additionally, the disclosure relates to a fluid comprising about 15 wt % to about 99 wt % polyphenyl oxide having the structure

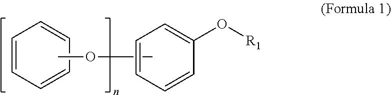

wherein R1 is a linear or branched C8-C12 alkyl group and n is 1 or 2, and about 1 wt % to about 25 wt % of an additive package. Furthermore, the disclosure includes a method of lubrication and/or thermal management of a system, involving contacting a surface with the aforementioned fluid.

### FIELD OF INVENTION

This application relates to polyphenyl oxides and their use in lubricant fluids and thermal management fluids.

### BACKGROUND

High energy density ICEs, hybrids, and EVs all require lubricants and dielectric coolants with exceptional high temperature stability. Conventional hydrocarbon formulations have relatively low stability at temperatures greater than about 200 °C. Per- and poly-fluorinated alkyl substances (PFAS) have been considered for such applications. However, PFAS, colloquially called “forever chemicals,” have been subject to standards/regulation. For example, 3M will discontinue manufacturing hydrofluoroether fluids (e.g., 3M Novec Engineered Fluids) by the end of 2025 (https://news.3 m.com/2022-12-20-3M-to-Exit-PFAS-Manufacturing-by-the-End-of-2025). Also, PFAS-based lubricants and coolants may lack the thermal conductivity and the heat capacity desired for use in high energy density systems.

Similar concerns regarding environmental acceptability, thermal conductivity, and heat capacity also apply for gear oils, industrial lubricants, and thermal management fluids, such as those required by server farms and similar sites.

Accordingly, there is a need for lubricant fluids and thermal management fluids with high temperature stability.

### SUMMARY OF INVENTION

In some aspects, the present disclosure relates to a compound, having the structure:

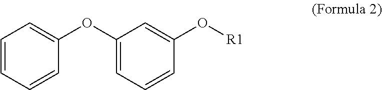

wherein R1 is:

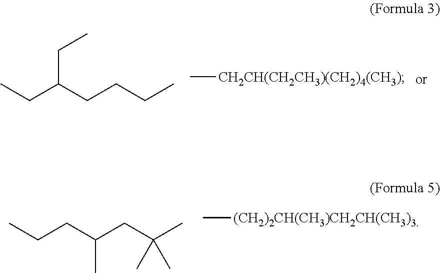

In some aspects, the present disclosure relates to a fluid, comprising: about 15 wt % to about 99 wt % polyphenyl oxide having the structure:

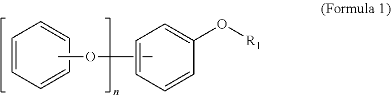

wherein R1 is a linear or branched C8-C12 alkyl group and n is 1 or 2; and about 1 wt % to about 25 wt % of an additive package.

In some aspects, the present disclosure relates to a method of lubrication and/or thermal management of a system, comprising: contacting a surface with a fluid comprising: about 15 wt % to about 99 wt % polyphenyl oxide having the structure:

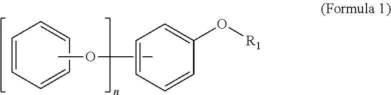

wherein R1 is a linear or branched C8-C12 alkyl group and n is 1 or 2; and about 1 wt % to about 25 wt % of an additive package.

### BRIEF DESCRIPTION OF THE DRAWINGS

Not applicable.

### DETAILED DESCRIPTION

As disclosed herein, certain polyphenyl oxides, such as diphenyl oxides with C8-C12 alkyl moieties, were found to combine exceptional oxidation stability in comparison to known alternatives with excellent low temperature properties.

### DEFINITIONS

As used herein, the term “wt. %,” and grammatical variations thereof, refer generally to percentage (also referred to herein as “percent” or “%”) by weight. As used herein, the term “vol. %,” and grammatical variations thereof, refer generally to percentage by volume. As used herein, the term “mol %,” and grammatical variations thereof, refer generally to percentage by mole. As used herein, the term “ppm,” and grammatical variations thereof, refer generally to parts per million. As used herein, the terms “ppm wt.,” “wppm,” and grammatical variations thereof, refer generally to parts per million on a weight basis. As used herein, the term “wt. ratio,” and grammatical variations thereof, refer generally to weight ratio. As used herein, the term “vol. ratio,” and grammatical variations thereof, refer generally to volume ratio. As used herein, the term “mol ratio,” and grammatical variations thereof, refer generally to mole ratio. All concentrations herein, unless otherwise stated, are expressed on the basis of the total amount of the composition in question.

As used herein, the terms “lubricant,” “lubricating oil,” “lubricant fluid,” and grammatical variations thereof, refer generally to a substance (usually a fluid under operating conditions) suitable for introduction between two moving surfaces of a system to reduce the friction and wear between said surfaces.

As used herein, the terms “thermal management fluid,” and grammatical variations thereof, refer generally to a substance (usually a fluid under operating conditions) suitable for conducting heat from one location of a system to a second location of the system, where the heat may be dissipated or used.

A fluid may be both a “lubricant fluid” and a “thermal management fluid.” Herein, the term “lubricant fluid” will encompass thermal management fluids unless expressly stated otherwise regarding a particular embodiment of the disclosure.

As used herein, the term “base oil,” and grammatical variations thereof, refer generally to the fluid component of a lubricant composition or lubricating oil composition, which may comprise one or more different oil base stocks.

As used herein, the term “oil base stock,” and grammatical variations thereof, refer generally to any fluid that could be used in a base oil, including, but not limited to, a terpene, a mineral oil, a synthetic hydrocarbon, an ester, the like, or any combination thereof. An oil base stock, as described herein, may be defined according to the American Petroleum Institute (API) base oil classification system, which categorizes oil base stocks into five groups based on their saturated hydrocarbon content, sulfur level.

As used herein, the terms “viscosity index,” “VI,” and grammatical variations thereof, refer generally to an empirical, unit-less number indicating the effect of temperature change on the kinematic viscosity of the oil base stock, base oil, or lubricant composition. A higher viscosity index indicates a smaller decrease in kinematic viscosity with increasing temperature. An oil base stock, base oil, or lubricant composition may have a VI value as determined by ASTM D2270.

Oil base stocks are typically produced on a large scale from non-renewable petroleum sources. As used herein, the term “Group I oil base stocks,” and grammatical variations thereof, refer generally to refined crude oils which are the least refined, undergoing solvent refining, comprising less than 90% saturates and/or greater than 0.03% sulfur, and having a viscosity index (VI) of about 80-120. As used herein, the term “Group II oil base stock,” and grammatical variations thereof, refer generally to refined crude oils which are more refined than Group I oil base stocks, both solvent refined and hydrocracked, to achieve more than 90% saturates, less than 0.03% sulfur, and having a viscosity index (VI) of about 80-120. As used herein, the term “Group III oil base stock,” and grammatical variations thereof, refer generally to refined crude oils which undergo severe hydro-processing (e.g., hydro-cracking, hydro-isomerization, and/or hydro-treating) to achieve the same refinement standards as Group II, while having a VI greater than 120.

As used herein, the term “Group IV oil base stock,” and grammatical variations thereof, refer generally to synthetic poly-α-olefins (PAOs) (e.g., produced by oligomerization of α-olefins, such as 1-decene, 1-butene, and propene), comprising conventional PAOs and metallocene PAOs (e.g., produced using a metallocene catalyst), typically with a VI of 125-300. Examples of suitable commercially available typical PAO co-oil base stocks include, but are not limited to, the SPECTRASYN™ series PAOs available from ExxonMobil (www.exxonmobilchemical.com and https://www.exxonmobil.com/en/basestocks) (e.g., SPECTRASYN™ 2 (e.g., PAO 2), SPECTRASYN™ 2C, SPECTRASYN™ 4 (e.g., PAO 4), SPECTRASYN™ 5 (e.g., PAO 5), SPECTRASYN™ 6 (e.g., PAO 6), SPECTRASYN™ 8 (e.g., PAO 8), SPECTRASYN™ 10 (e.g., PAO 10), SPECTRASYN™ 40 (e.g., PAO 40), SPECTRASYN™ 65 (e.g., PAO 65), SPECTRASYN™ 100 (e.g., PAO 100), and SPECTRASYN™ 150 (e.g., PAO 150)). Examples of suitable commercially available metallocene PAOs (mPAOs) include, but are not limited to, the SPECTRASYN ELITE™ series mPAOs available from ExxonMobil (www.exxonmobilchemical.com) (e.g., SPECTRASYN ELITE™ 65, SPECTRASYN ELITE™ 150, and SPECTRASYN ELITE™ 300), and the DURASYN® series available from Ineos (www.ineos.com) (e.g., DURASYN® 180R (e.g., mPAO 100)).

As used herein, the term “Group V oil base stock,” and grammatical variations thereof, refer generally to include all base stocks that do not belong to Groups I-IV, such as alkylated naphthalenes, alkylated benzenes, polyalkylene glycols (PAG), and esters.

Further designations commonly used by oil producers, but not officially recognized by the API, may be used, including Group II+ oil base stocks and Group III+ oil base stocks. As used herein, the term “Group II+ oil base stock,” and grammatical variations thereof, refer generally to Group II oil base stock which are further treated (e.g., hydro-treated) to have a VI of from about 110 to about 120. As used herein, the term “Group III+ oil base stock,” and grammatical variations thereof, refer generally to synthetic oils, e.g., produced by Fischer-Tropsch reactions of hydrogen and carbon monoxide (e.g., CTL oil base stocks, GTL oil base stocks) having a VI of approximately 135-145.

Oil base stocks may be alternatively defined by a viscosity and/or volatility grade classification, which varies from producer to producer. Generally, viscosity grade classifications range in order of increasing viscosity and mid-point boiling point. As used herein, the terms “kinematic viscosity,” “KV,” and grammatical variations thereof, refer generally to the ratio of the dynamic viscosity to the density of a material at the same temperature and pressure. The gear oil compositions may have a KV measured at a defined temperature as defined by ASTM D445 or ASTM D7279 or ASTM D7042. Shorthand terms for kinematic viscosity at commonly used defined temperatures are KV100 (e.g., 100 °C) and KV40 (e.g., 40 °C).

Additive package herein may refer to a commercial additive package or a combination of various individual additives.

### Polyphenyl Oxides

In some aspects, the present disclosure relates to a polyphenyl oxide having the structure:

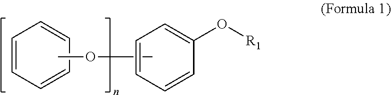

wherein R1 is a linear or branched C8-C12 alkyl group and n is 1 or 2. A “linear” alkyl group is one in which all carbon atoms are primary or secondary carbons. A “branched” alkyl group is one in which at least one carbon atom is a tertiary or quaternary carbon. Polyphenyl oxides in which n is 1 may be referred to herein as “diphenyl oxides.”

Polyphenyl oxides having the structure of Formula 1 will have one or two phenyl groups each comprising two ether (—O—) substituents. For such phenyl groups, the ether substituents may be ortho (on adjacent carbon atoms of the phenyl ring), meta (on carbon atoms of the phenyl ring separated by one carbon atom), or para (on carbon atoms across the phenyl ring) to each other.

In some embodiments, the polyphenyl oxide is a diphenyl oxide having the structure:

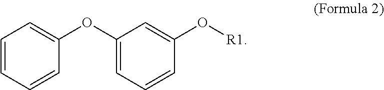

In some embodiments, R1 is a branched C8-C12 alkyl group. For example, R1 may have the structure:

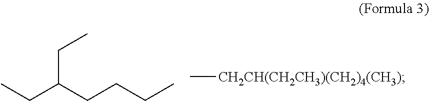

in which case a diphenyl oxide comprising R1 is 1-((2-ethylhexyl)oxy)-3-phenoxybenzene,

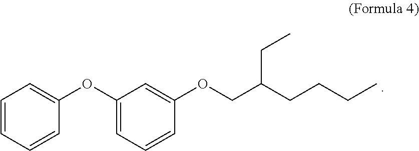 [SMILES: CCCCC(CC)COc1cccc(Oc2ccccc2)c1]

For another example, R1 may have the structure:

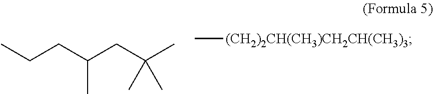

in which case a diphenyl oxide comprising R1 is 1-((3,5,5-trimethylhexyl)oxy)-3-phenoxybenzene,

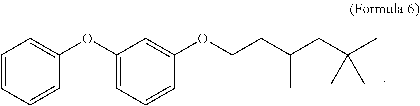 [SMILES: CC(CCOc1cccc(Oc2ccccc2)c1)CC(C)(C)C]

Diphenyl oxides with branched C8-C12 alkyl R1 groups, such as 1-((2-ethylhexyl)oxy)-3-phenoxybenzene and 1-((3,5,5-trimethylhexyl)oxy)-3-phenoxybenzene, may have high stability under high temperatures. For example, diphenyl oxides with branched C8-C12 alkyl R1 groups may have oxidation onset temperatures, as determined by ASTM E2009-08 Test Method B or methods similar thereto, greater than about a1 °C, wherein a1 is 295, 300, 305, 310, 315, or 320, including all values and subranges therebetween. For example, diphenyl oxides with branched C8-C12 alkyl R1 groups may have oxidation onset temperatures greater than 320 °C. This paragraph refers to oxidation onset temperatures of the diphenyl oxides per se (greater than about 97% purity as determined by gas chromatography), and not to formulations comprising the diphenyl oxides and antioxidants.

Diphenyl oxides with branched C8-C12 alkyl R1 groups, such as 1-((2-ethylhexyl)oxy)-3-phenoxybenzene and 1-((3,5,5-trimethylhexyl)oxy)-3-phenoxybenzene, may have excellent low temperature properties. For example, diphenyl oxides with branched C8-C12 alkyl R1 groups may have pour points less than about b1 °C, wherein b1 is −65, −70, −75, −80, −85, −90, or −95, including all values and subranges therebetween. This paragraph refers to pour points of the diphenyl oxides per se, and not to formulations comprising the diphenyl oxides and pour point depressants.

In some embodiments, R1 is a linear C8-C12 alkyl group. For example, R1 may have the structure:

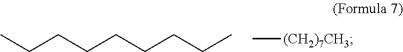

in which case a diphenyl oxide comprising R1 is 1-((n-octyl)oxy)-3-phenoxybenzene,

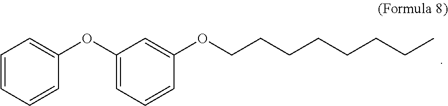 [SMILES: CCCCCCCCOc1cccc(Oc2ccccc2)c1]

For another example, R1 may have the structure:

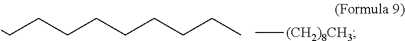

in which case a diphenyl oxide comprising R1 is 1-((n-nonyl)oxy)-3-phenoxybenzene,

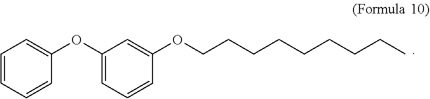

### Fluids Comprising Polyphenyl Oxides

In some aspects, the present disclosure relates to a fluid, comprising about 15 wt % to about 99 wt % polyphenyl oxide; and about 1 wt % to about 25 wt % of an additive package. The weight percentages are relative to the complete fluid formulation.

The polyphenyl oxide may be as described herein. For example, the polyphenyl oxide may be a diphenyl oxide having the structure of Formula 2, wherein R1 is a branched C8-C12 alkyl group, e.g., R1 is a 2-ethylhexyl group or a 3,5,5-trimethylhexyl group.

The polyphenyl oxide may comprise two or more polyphenyl oxides each comprising the structure of Formula 1, wherein R1 is a linear or branched C8-C12 alkyl group. For example, the polyphenyl oxide may comprise two or more diphenyl oxides each comprising the structure of Formula 2, wherein R1 is a branched C8-C12 alkyl group.

The fluid may comprise from about c1 wt % to about c2 wt % polyphenyl oxide, where c1 and c2 may be, independently, 15, 20, 25, 30, 35, 40, 45, 50, 55, 60, 65, 70, 75, 80, 85, 90, 95, or 99 and c1<c2. For example, the fluid may comprise about 15 wt % to about 99 wt %, about 15 wt % to about 50 wt %, about 25 wt % to about 60 wt %, about 35 wt % to about 70 wt %, about 45 wt % to about 80 wt %, about 55 wt % to about 90 wt %, about 60 wt % to about 95 wt %, about 70 wt % to about 95 wt %, or about 75 wt % to about 99 wt % of the polyphenyl oxide, including all values and subranges therebetween.

The fluid may comprise about 1 wt % to about 25 wt % of an additive package. The additive package may be any additive package suitable for an intended use (e.g., lubrication and/or thermal management) and/or in an intended application (e.g., internal combustion engine oils, hybrid engine oils, electric vehicle oils, gear oils, industrial lubricants, and/or server farm thermal management fluids).

For example, additive packages for use in lubricant fluids or thermal management fluids may comprise one or more antioxidants, antiwear agents, antifoaming agents, metal passivators, friction modifiers, pour point improvers, corrosion inhibitors, detergents, dispersants, or any combination thereof.

Antioxidants retard the oxidative degradation of base oils during service. Such degradation may result in deposits on metal surfaces, the presence of sludge, or a viscosity increase in the fluid. One skilled in the art knows a wide variety of oxidation inhibitors that are useful in fluids. See, U.S. Pat. Nos. 4,798,684 and 5,084,197, for example.

Suitable antioxidants for use in the fluid include, but are not limited to, amine-based antioxidants (e.g., alkylated diphenylamine, phenyl-α-naphthylamine, and alkylated phenyl-x-naphthylamine); phenol-based antioxidants (e.g., 4,4′-methylenebis-(2,6-di-t-butylphenol), 2,6-di-t-butyl phenol, and isooctyl-3-(3,5-di-t-butyl-4-hydroxyphenyl)propionate); sulfur-based antioxidants (e.g., dilauryl-3,3′-thiodipropionate); zinc dithiophosphate, the like, and any combination thereof.

Useful antioxidants may include hindered phenols. These phenolic antioxidants may be ashless phenolic compounds or neutral or basic metal salts of certain phenolic compounds. Typical phenolic antioxidant compounds include hindered phenolics, which contain a sterically hindered hydroxyl group, e.g., derivatives of dihydroxy aryl compounds in which the hydroxyl groups are in the o- or p-position to each other. Typical phenolic antioxidants include hindered phenols substituted with C6+ alkyl groups and alkylene coupled derivatives of these hindered phenols. Examples of phenolic materials of this type include, but are not limited to, 2-t-butyl-4-heptyl phenol; 2-t-butyl-4-octyl phenol; 2-t-butyl-4-dodecyl phenol; 2,6-di-t-butyl-4-heptyl phenol; 2,6-di-t-butyl-4-dodecyl phenol; 2-methyl-6-t-butyl-4-heptyl phenol; and 2-methyl-6-t-butyl-4-dodecyl phenol. Other useful hindered mono-phenolic antioxidants may include, for example, hindered 2,6-di-alkyl-phenolic proprionic ester derivatives. Bis-phenolic antioxidants may also be used. Examples of ortho-coupled phenols include: 2,2′-bis(4-heptyl-6-t-butyl-phenol); 2,2′-bis(4-octyl-6-t-butyl-phenol); and 2,2′-bis(4-dodecyl-6-t-butyl-phenol). Para-coupled bisphenols include, for example, 4,4′-bis(2,6-di-t-butyl phenol) and 4,4′-methylene-bis(2,6-di-t-butyl phenol).

Non-phenolic oxidation inhibitors which may be used include aromatic amine antioxidants, which may be used either as such or in combination with phenolics. Typical examples of non-phenolic antioxidants include: alkylated and non-alkylated aromatic amines such as aromatic monoamines of the formula R8R9R10N where R8 is an aliphatic, aromatic or substituted aromatic group, R9 is an aromatic or a substituted aromatic group, and R10 is H, alkyl, aryl or R11S(O)XR12 where R11 is an alkylene, alkenylene, or aralkylene group, R12 is a higher alkyl group, or an alkenyl, aryl, or alkaryl group, and x is 0, 1 or 2. The aliphatic group R8 may contain from 1 to about 20 carbon atoms, e.g., from about 6 to 12 carbon atoms. The aliphatic group may be a saturated aliphatic group. Both R8 and R9 may be aromatic or substituted aromatic groups, and the aromatic group may be a fused ring aromatic group such as naphthyl. Aromatic groups R8 and R9 may be joined together with other groups such as sulfur.

Typical aromatic amine antioxidants have alkyl substituent groups of at least about 6 carbon atoms. Examples of aliphatic groups include hexyl, heptyl, octyl, nonyl, and decyl. Generally, the aliphatic groups will not contain more than about 14 carbon atoms. General types of amine antioxidants include diphenylamines, phenyl naphthylamines, phenothiazines, imidodibenzyls and diphenyl phenylene diamines. Mixtures of two or more aromatic amines may also be useful. Polymeric amine antioxidants may also be used. Particular examples of aromatic amine antioxidants include: p,p′-dioctyldiphenylamine; t-octylphenyl-alpha-naphthylamine; phenyl-alphanaphthylamine; and p-octylphenyl-alpha-naphthylamine. Sulfurized alkyl phenols and alkali or alkaline earth metal salts thereof may also be used.

Particular antioxidants include hindered phenols and arylamines. These antioxidants may be used individually by type or in combination with one another.

Other suitable aminic antioxidants include, but are not limited to, polymeric or oligomeric amines which are the polymerization reaction products of one or more substituted or hydrocarbyl-substituted diphenyl amines, one or more unsubstituted or hydrocarbyl-substituted phenyl naphthyl amines, or both one or more of unsubstituted or hydrocarbyl-substituted diphenylamine with one or more unsubstituted or hydrocarbyl-substituted phenyl naphthylamine. A representative schematic is presented below:

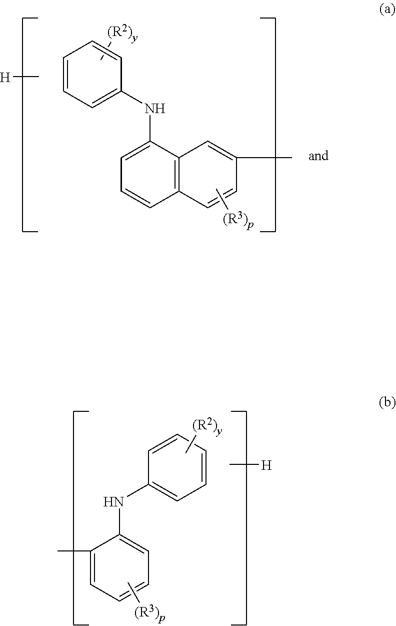

wherein (a) and (b) each range from zero to 10, preferably zero to 5, more preferably zero to 3, most preferably 1 to 3, provided (a)+(b) is at least 2, for example:

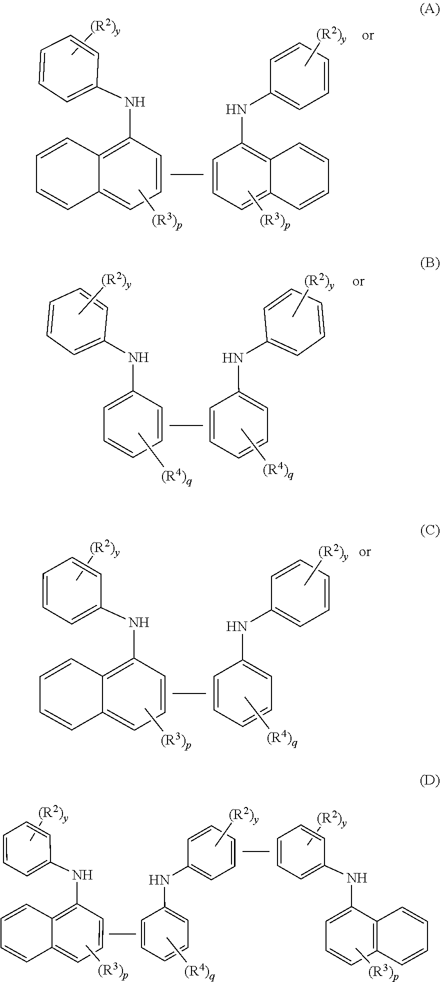

where R² is a styrene or C₁ to C₃₀alkyl, R³ is a styrene or C₁ to C₃₀alkyl, R⁴ is a styrene or C₁ to C₃₀alkyl, preferably R₂ is a C₁ to C₃₀alkyl, R₃ is a C₁ to C₃₀alkyl, R₄ is a C₁ to C₃₀alkyl, more preferably R₂ is a C₄ to C₁₀ alkyl, R₃ is a C₄ to C₁₀ alkyl and R₄ is a C₄ to C₁₀ alkyl, p, q and y individually range from 0 to up to the valence of the aryl group to which the respective R group(s) are attached, preferably at least one of p, q and y range from 1 to up to the valence of the aryl group to which the respective R group(s) are attached, more preferably p, q and y each individually range from at least 1 to up to the valence of the aryl group to which the respective R groups are attached. Other more extensive oligomers are within the scope of this disclosure, but materials of formulae A, B, C and D may be particularly suitable. Examples can also be found in U.S. Pat. No. 8,492,321.

Antioxidants may be used in an amount of about 0.01 wt % to 10 wt %, such as about 0.01 wt % to about 1.5 wt %, e.g., zero to less than 1.5 wt %, or zero, based on the total weight of the fluid.

Suitable anti-wear agents may be zinc-based or zinc-free, phosphorous-based or phosphorous-free, or any combination thereof. Suitable zinc-free antiwear agents may comprise amine phosphates and dialkyldithiophosphate esters. Suitable anti-wear agents may comprise about 0 parts per million (ppm) to about 1,400 ppm of zinc, including all ppm values and subsets therebetween (e.g., zinc-based anti-wear agents may comprise about 400 ppm to about 1,200 ppm, or about 600 ppm to about 1,000 ppm zinc); and/or about 0 ppm to about 1,400 ppm of phosphorus, including all ppm values and subsets therebetween (e.g., phosphorous-based anti-wear agents may comprise about 400 ppm to about 1,200 ppm, or about 600 ppm to about 1,000 ppm phosphorous), based on the total weight of the fluid. Anti-wear agents may be ashless anti-wear agents.

Zinc-based anti-wear agents include zinc dithiophosphates, including those which are commercially available from, for example, The Lubrizol Corporation under the trade designations “LZ 677A”, “LZ 1095” and “LZ 1371”; Chevron Oronite under the trade designations “OLOA 269R” and “OLOA 262”; and Afton Chemical under the trade designation “HITEC 7169”.

Suitable antifoaming agents may include, but are not limited to, dimethyl polysiloxane, polyacrylate and fluorine derivatives thereof, perfluoropolyether, and combinations thereof.

Suitable friction modifiers may include, but are not limited to, an organomolybdenum-based compound, fatty acid, higher alcohol, fatty acid ester, oil/fat, amine, polyamide, sulfide ester, phosphoric acid ester, acid phosphoric acid ester, acid phosphorous acid ester, amine salt of phosphoric acid ester, and combinations thereof.

One or more corrosion inhibitors may be added to the fluids. Corrosion inhibitors are additives that protect lubricated metal surfaces against chemical attack by water or other contaminants. Corrosion inhibitors may also be used to reduce the degradation of metallic parts that are in contact with a fluid. As used herein, corrosion inhibitors include anti-rust additives, metal deactivators, and metal passivators.

Suitable corrosion inhibitors may include, but are not limited to, a fatty acid, alkenylsuccinic acid half ester, fatty acid soap, alkylsulfonate, polyhydric alcohol/fatty acid ester, fatty acid amine, oxidized paraffin, and alkylpolyoxyethylene ether, the like, and any combination thereof. Suitable corrosion inhibitors may be metal passivators.

Suitable pour point improvers may include, but are not limited to, pour point depressants. Suitable pour point depressants may include, but are not limited to, ethylene/vinyl acetate copolymer, condensate of chlorinated paraffin and naphthalene, condensate of chlorinated paraffin and phenol, polymethacrylate, polyalkyl styrene, the like, and any combination thereof. Suitable defoamers may include, but are not limited to, dimethyl polysiloxane, polyacrylate and a fluorine derivative thereof, perfluoropolyether, the like, and any combination thereof.

During engine operation, oil-insoluble oxidation byproducts are produced. Dispersants help keep these byproducts in solution, thus diminishing their deposition on metal surfaces. Dispersants may be ashless or ash-forming in nature. In some embodiments, the dispersant is ashless. Ashless dispersants are organic materials that form substantially no ash upon combustion. For example, non-metal-containing or borated metal-free dispersants are considered ashless. In contrast, metal-containing detergents may form ash upon combustion.

Suitable dispersants typically contain a polar group attached to a relatively high molecular weight hydrocarbon chain. The polar group typically contains at least one element of nitrogen, oxygen, or phosphorus. Typical hydrocarbon chains contain 50 to 400 carbon atoms.

Chemically, many dispersants may be characterized as phenates, sulfonates, sulfurized phenates, salicylates, naphthenates, stearates, carbamates, thiocarbamates, or phosphorus derivatives. A particularly useful class of dispersants are the alkenylsuccinic derivatives, typically produced by the reaction of a long chain substituted alkenyl succinic compound, usually a substituted succinic anhydride, with a polyhydroxy or polyamino compound. The long chain group constituting the oleophilic portion of the molecule which confers solubility in the oil, is normally a polyisobutylene group. Many examples of this type of dispersant are well known commercially and in the literature. Exemplary U.S. patents describing such dispersants are U.S. Pat. Nos. 3,172,892; 3,215,707; 3,219,666; 3,316,177; 3,341,542; 3,444,170; 3,454,607; 3,541,012; 3,630,904; 3,632,511; 3,787,374; and 4,234,435. Other types of dispersants are described in U.S. Pat. Nos. 3,036,003; 3,200,107; 3,254,025; 3,275,554; 3,438,757; 3,454,555; 3,565,804; 3,413,347; 3,697,574; 3,725,277; 3,725,480; 3,726,882; 4,454,059; 3,329,658; 3,449,250; 3,519,565; 3,666,730; 3,687,849; 3,702,300; 4,100,082; and 5,705,458. A further description of dispersants may be found, for example, in European Patent Application No. 471 071, to which reference is made for this purpose.

Hydrocarbyl-substituted succinic acid compounds are popular dispersants. In particular, succinimide, succinate esters, or succinate ester amides prepared by the reaction of a hydrocarbon-substituted succinic acid compound, e.g., a succinic acid compound having at least 50 carbon atoms in the hydrocarbon substituent, with at least one equivalent of an alkylene amine are particularly useful.

Succinimides are formed by the condensation reaction between alkenyl succinic anhydrides and amines. Molar ratios can vary depending on the polyamine. For example, the molar ratio of alkenyl succinic anhydride to polyethylene amines (TEPA, tetra-ethylene penta-amine) can vary from about 1:1 to about 5:1. Representative examples are shown in U.S. Pat. Nos. 3,087,936; 3,172,892; 3,219,666; 3,272,746; 3,322,670; 3,652,616; and 3,948,800; and Canada Pat. No. 1,094,044.

Succinate esters are formed by the condensation reaction between alkenyl succinic anhydrides and alcohols or polyols. Molar ratios can vary depending on the alcohol or polyol used. For example, the condensation product of an alkenyl succinic anhydride and pentaerythritol is a useful dispersant.

Succinate ester amides are formed by condensation reaction between alkenyl succinic anhydrides and alkanol amines. For example, suitable alkanol amines include ethoxylated polyalkylpolyamines, propoxylated polyalkylpolyamines and polyalkenylpolyamines, such as polyethylene polyamines. One example is propoxylated hexamethylenediamine. Representative examples are shown in U.S. Pat. No. 4,426,305.

The molecular weight of the alkenyl succinic anhydrides used in the preceding paragraphs will typically range between 800 and 2,500 g/mol. The above products can be post-reacted with various reagents such as sulfur, oxygen, formaldehyde, carboxylic acids such as oleic acid, and boron compounds such as borate esters or highly borated dispersants. The dispersants can be borated with from about 0.1 to about 5 moles of boron per mole of dispersant reaction product.

Mannich base dispersants are made from the reaction of alkylphenols, formaldehyde, and amines. See U.S. Pat. No. 4,767,551, which is incorporated herein by reference. Process aids and catalysts, such as oleic acid and sulfonic acids, can also be part of the reaction mixture. Molecular weights of the alkylphenols range from 800 to 2,500 g/mol. Representative examples are shown in U.S. Pat. Nos. 3,697,574; 3,703,536; 3,704,308; 3,751,365; 3,756,953; 3,798,165; and 3,803,039.

Typical high molecular weight aliphatic acid modified Mannich condensation products useful in this invention can be prepared from high molecular weight alkyl-substituted hydroxyaromatics or HN(R)2 group-containing reactants. Hydrocarbyl substituted amine ashless dispersant additives are well known to one skilled in the art; see, for example, U.S. Pat. Nos. 3,275,554; 3,438,757; 3,565,804; 3,755,433; 3,822,209; and 5,084,197.

Exemplary dispersants include borated and non-borated succinimides, including those derivatives from mono-succinimides, bis-succinimides, and/or mixtures of mono- and bis-succinimides, wherein the hydrocarbyl succinimide is derived from a hydrocarbylene group such as polyisobutylene having a molecular weight number average (Mn) of from about 500 to about 5000 g/mol or a mixture of such hydrocarbylene groups. Other exemplary dispersants include succinic acid-esters and amides, alkylphenol-polyamine-coupled Mannich adducts, their capped derivatives, and other related components. Such additives may be used in an amount of about 0.1 to 20 wt %, such as about 0.5 to 8 wt %.

Overall, the fluid may comprise about d1 wt % to about d2 wt % of the additive package, where d1 and d2 may be, independently, 5, 10, 15, 20, or 25 and d1<d2. For example, the fluid may comprise about 5 wt % to about 25 wt %, about 10 wt % to about 25 wt %, or about 15 wt % to about 20 wt % of the additive package, including all values and subranges therebetween.

In some embodiments, the fluid may further comprise about 5 wt % to about 85 wt % Group I/II/III/IV/V oil base stock.

The Group I/II/III/IV/V oil base stock may be an oil base stock selected from the group consisting of Group I oil base stocks, Group II oil base stocks, Group III oil base stocks, Group I+ oil base stocks, Group II+ oil base stocks, Group III+ oil base stocks, Group IV oil base stocks, Group V oil base stocks, and any combination thereof. For example, the Group I/II/III/IV/V oil base stock may be a Group III oil base stock.

When a Group I/II/III/IV/V oil base stock is included, the fluid may comprise about e1 wt % to about e2 wt % Group I/II/III/IV/V oil base stock, where e1 and e2 may be, independently, 5, 10, 15, 20, 25, 30, 35, 40, 45, 50, 55, 60, 65, 70, 75, 80, or 85, and e1<e2. For example, the fluid may comprise about 5 wt % to about 85 wt %, about 5 wt % to about 25 wt %, about 15 wt % to about 35 wt %, about 25 wt % to about 45 wt %, about 35 wt % to about 55 wt %, about 45 wt % to about 55 wt %, about 55 wt % to 65 wt %, about 65 wt % to about 75 wt %, or about 75 wt % to about 85 wt %.

In some embodiments, the fluid may further comprise a viscosity index improver. Viscosity index improvers are also known as VI improvers, viscosity modifiers, and viscosity improvers. Suitable viscosity index improvers provide fluids with high temperature and low temperature operability. Suitable viscosity modifiers also impart shear stability at elevated temperatures and acceptable viscosity at low temperatures. Viscosity index improvers may be of particular interest in fluids formulated as engine oils.

Suitable viscosity modifiers may be or may include one or more linear or star-shaped polymers and/or copolymers of methacrylate, butadiene, olefins, isoprene or alkylated styrenes, polyisobutylene, polymethacrylate, ethylene-propylene, hydrogenated block copolymer of styrene and isoprene, polyacrylates, styrene-isoprene block copolymer, styrene-butadiene copolymer, ethylene-propylene copolymer, hydrogenated star polyisoprene, and combinations thereof.

When a viscosity improver is included, the fluid may comprise about f1 wt % to about f2 wt % of the viscosity improver, wherein f1 and f2 may be, independently, 3, 4, 5, 6, 7, 8, 9, or 10, and f1<f2. In non-limiting examples, f1 is 3 and f2 is 6; f1 is 5 and f2 is 8; or f1 is 7 and f2 is 10.

A fluid according to the present disclosure may have one or more desirable properties. For example, the fluid may have a KV40 of about 15 to about 60 cSt (or mm2/s), as determined pursuant to ASTM D445.

For another example, the fluid may have a KV100 of about 2 to about 16 cSt (or mm2/s), as determined pursuant to ASTM D445.

For yet another example, the fluid may have an oxidation onset temperature, as determined by ASTM E2009-08 Test Method B or methods similar thereto, greater than about c1 °C, where c1 is 295, 300, 305, 310, 315, 320, 325, 330, 335, 340, 345, or 350, including all values and subranges therebetween.

For still another example, the fluid may have a friction coefficient at 140 °C less than about d1, wherein d1 is 0.1, 0.09, 0.08, 0.07, 0.06, 0.05, 0.04, 0.03, 0.02, or 0.01, including all values and subranges therebetween. For example, d1 may be 0.08. The friction coefficient may be measured by minitraction machine (MTM).

For an additional example, the fluid may have a total metal content of less than 0.05 wt %.

Methods of Lubrication and/or Thermal Management

In some aspects, the present disclosure relates to a method of lubrication and/or thermal management of a system, comprising contacting a surface with a fluid. The fluid may be as described above. For example, the fluid may comprise a diphenyl oxide having the structure of Formula 2, wherein R1 is a branched C8-C12 alkyl group, e.g., R1 is a 2-ethylhexyl group or a 3,5,5-trimethylhexyl group.

For example, the method may lubricate the surface. Such a surface may be a bearing, a gear, at least a portion of an electric motor, a clutch, a gearbox, or any combination thereof. The fluid may be circulated while contacting the surface.

Alternatively or additionally, the method may provide thermal management to the surface. Such a surface may be a heatsink or other component of a computational device, e.g., a server in a server farm. The fluid may be circulated while contacting the surface.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

In some aspects, the present disclosure relates to one or more of the following embodiments.

1. A compound, having the structure:

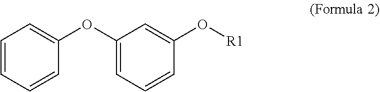

wherein R1 is:

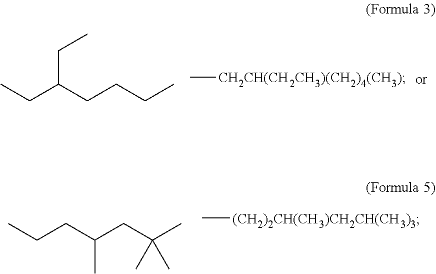

2. The compound of embodiment 1, which is 1-((2-ethylhexyl)oxy)-3-phenoxybenzene,

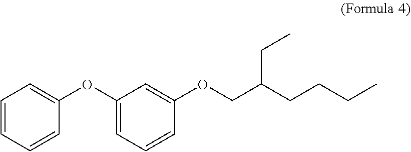 [SMILES: CCCCC(CC)COc1cccc(Oc2ccccc2)c1]

3. The compound of embodiment 1, which is 1-((3,5,5-trimethylhexyl)oxy)-3-phenoxybenzene,

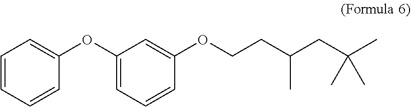 [SMILES: CC(CCOc1cccc(Oc2ccccc2)c1)CC(C)(C)C]

4. A fluid, comprising: about 15 wt % to about 99 wt % polyphenyl oxide having the structure:

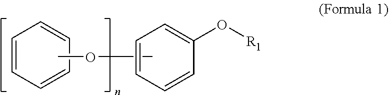

wherein R1 is a linear or branched C8-C12 alkyl group and n is 1 or 2; and about 1 wt % to about 25 wt % of an additive package.

5. The fluid of embodiment 4, wherein R1 is:

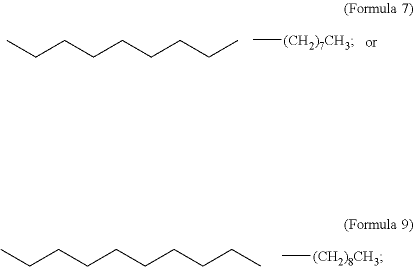

6. The fluid of embodiment 4, wherein R1 comprises at least one tertiary or quaternary carbon.

7. The fluid of embodiment 4, wherein R1 is:

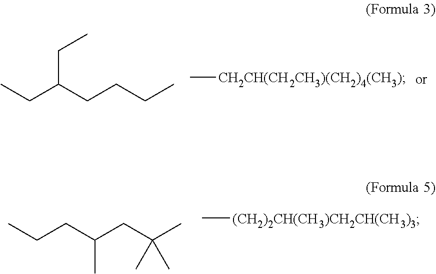

8. The fluid of any of embodiments 4-7, wherein the polyphenyl oxide is a diphenyl oxide having the structure:

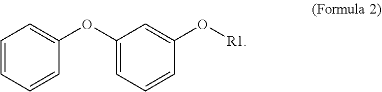

9. The fluid of embodiment 8, wherein R1 is a linear C8-C12 alkyl group.

10. The fluid of embodiment 9, wherein R1 is:

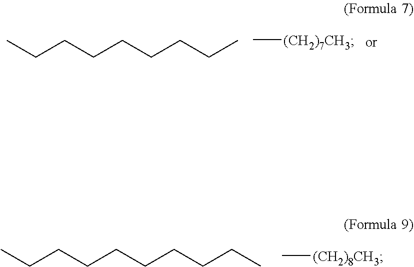

11. The fluid of embodiment 8, wherein R1 is a branched C8-C12 alkyl group.

12. The fluid of embodiment 11, wherein the diphenyl oxide has a pour point less than about 65 °C.

13. The fluid of any of embodiments 11-12, wherein the diphenyl oxide has an oxidation onset temperature greater than about 295 °C.

14. The fluid of any of embodiments 11-13, wherein R1 comprises at least one tertiary or quaternary carbon.

15. The fluid of any of embodiments 11-14, wherein R1 is:

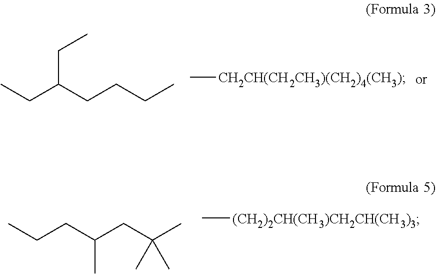

16. The fluid of any of embodiments 4-15, wherein the additive package comprises an additive selected from the group consisting of antioxidants, antiwear agents, antifoaming agents, metal passivators, friction modifiers, pour point improvers, corrosion inhibitors, detergents, dispersants, and any combination thereof.

17. The fluid of any of embodiments 4-16, further comprising about 5 wt % to about 85 wt % Group I/II/II/IV/V oil base stock.

18. The fluid of any of embodiments 4-17, further comprising about 3 wt % to about 10 wt % viscosity improver.

19. The fluid of any of embodiments 4-18, wherein the fluid has a friction coefficient at 140 °C of 0.08 or below as measured by minitraction machine (MTM).

20. A method of lubrication and/or thermal management of a system, comprising: contacting a surface with a fluid comprising: about 15 wt % to about 99 wt % polyphenyl oxide having the structure:

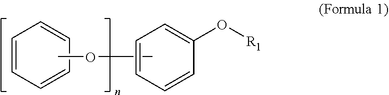

wherein R1 is a linear or branched C8-C12 alkyl group and n is 1 or 2; and about 1 wt % to about 25 wt % of an additive package.

21. The method of embodiment 20, wherein the polyphenyl oxide is a diphenyl oxide having the structure:

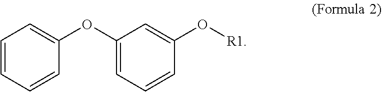

22. The method of any of embodiments 20-21, wherein R1 is:

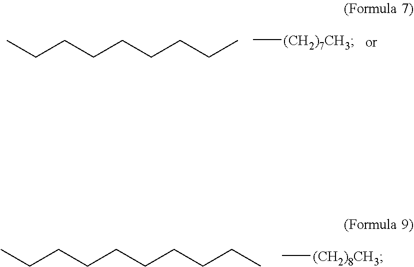

23. The method of any of embodiments 20-21, wherein R1 comprises at least one tertiary or quaternary carbon.

24. The method of any of embodiments 20-23, wherein R1 is:

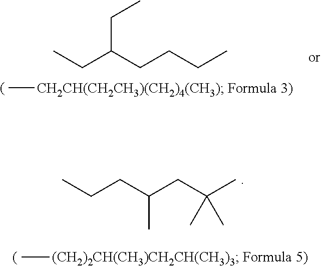

25. The method of embodiment 20, wherein the surface is a bearing, a gear, at least a portion of an electric motor, a clutch, a gearbox, or any combination thereof.

26. The method of embodiment 25, wherein the fluid is circulated while contacting the surface.

To facilitate a better understanding of the embodiments of the present invention, the following examples of preferred or representative embodiments are given. In no way should the following examples be read to limit, or to define, the scope of the invention.

### Examples

Synthesis of Diphenyl Oxides. Four diphenyl oxides, Examples 1-4, were synthesized as exemplified by reference to the synthesis of Example 3. 1-((2-ethylhexyl)oxy)-3-phenoxybenzene was synthesized by reacting 3-bromophenol and 1-bromo-2-ethylhexane with a base to produce 1-bromo-3-((2-ethylhexyl)oxy)benzene (Intermediate 1) in greater than 80% yield. Reaction of Intermediate 1 with phenol via Ullmann coupling produced Example 3 in 70% yield. The products were purified by flash column chromatography. Examples 1-2 and 4 were synthesized by reacting 3-bromophenol with corresponding brominated alkanes.

Properties of Diphenyl Oxides. Purity of Examples 1-4 was confirmed by gas chromatography (GC) to be greater than 97%. Kinematic viscosity was determined at 40 °C and 100 °C according to ASTM D445. Noack volatility was determined by a thermal gravimetric method similar to ASTM D6375. Pour point was determined by ASTM D7346. Thermal conductivity was determined using a TCi Thermal Conductivity Analyzer (available from C-Therm Technologies Ltd., Fredericton, New Brunswick, Canada).

Oxidation onset temperature was measured by high pressure Differential Scanning Calorimetry (hpDSC) using a Universal V4.5A TA instrument equipped with a Q20 Tzero Pressure DSC Cell. The test method was similar to ASTM E2009-08 Test Method B except that 500 psig of purified air was used instead of 500 psig of oxygen and the sample size was 3.0±0.2 mg. The pressurized sample was first equilibrated at 50 °C and then ramped up to 400 °C at 10 °C/min.

Properties of Examples 1-4 are given in Table 1 below. Comparative Example 1 (CE1) was a commercially-available Group IV PAO base stock.

TABLE 1

| | | | | | | Thermal | |
|---|---|---|---|---|---|---|---|
| | | | Est. | Pour | hpDSC | Conduc- | Density |
| | KV100 | KV40 | Noack | Point | (air) | tivity | @ 40° C. |
| | (cSt) | (cSt) | (%) | (° C.) | (° C.) | (W/mK) | (g/ml) |
| CE 1 | 4.1 | | | | 210 | | |
| Group | | | | | | | |
| IV | | | | | | | |
| PAO | | | | | | | |
| Example 1 | 2.5 | 10.5 | 27 | −60 | 287 | 0.13 | 0.94 |
| 1-((n-octyl)oxy)-3- | | | | | | | |
| phenoxybenzene | | | | | | | |
| 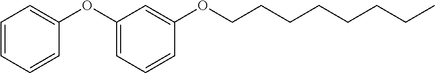 [SMILES: CCCCCCCCOc1cccc(Oc2ccccc2)c1] | | | | | | | |
| Example 2 | 2.8 | 11.1 | 16 | −57 | 280 | 0.13 | 0.98 |
| 1-((n-nonyl)oxy)-3- | | | | | | | |
| phenoxybenzene | | | | | | | |
| 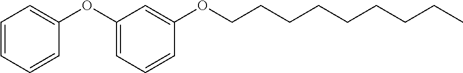 [SMILES: CCCCCCCCCOc1cccc(Oc2ccccc2)c1] | | | | | | | |
| Example 3 | 2.5 | 12.3 | 32 | <−95 | 271 | 0.13 | 0.97 |
| 1-((2- | | | | | | | |
| ethylhexyl)oxy)-3- | | | | | | | |
| phenoxybenzene | | | | | | | |
| 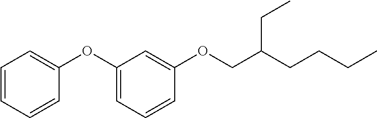 [SMILES: CCCCC(CC)COc1cccc(Oc2ccccc2)c1] | | | | | | | |
| Example 4 | 2.7 | 12.1 | 27 | <−95 | 320 | 0.11 | 0.97 |
| 1-((3,5,5- | | | | | | | |
| trimethylhexyl)oxy)- | | | | | | | |
| 3-phenoxybenzene | | | | | | | |
| 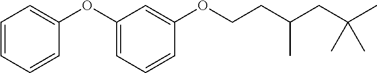 [SMILES: CC(CCOc1cccc(Oc2ccccc2)c1)CC(C)(C)C] | | | | | | | |

Fluid Formulations. Inventive Fluid 1 (IF1) was formulated with Example 3 and additives known for lubricant and coolant fluids. Prophetic Fluids 1-3 (PF1-PF3) are formulated with Example 1, Example 2, and Example 4, respectively, and additives known for lubricant and coolant fluids. Amounts of all components of Inventive Fluid 1 and Prophetic Fluids 1-3 are given in Table 2.

Properties of Fluid Formulations. Kinematic viscosity and oxidation onset temperature were measured for Inventive Fluid 1 and are measured for Prophetic Fluids 1-3 as described under Properties of Diphenyl Oxides, supra. High Temperature High Shear Viscosity was measured for Inventive Fluid 1 and is measured for Prophetic Fluids 1-3 according to ASTM D4683. Boron, calcium, magnesium, molybdenum, phosphorous, and zinc contents were measured for Inventive Fluid 1 and are measured for Prophetic Fluids 1-3 according to ASTM 4951. Sulfur contents were measured for Inventive Fluid 1 and are measured for Prophetic Fluids 1-3 according to ASTM D6443.

Friction coefficient was assessed for Inventive Fluid 1 and is assessed for Prophetic Fluids 1-3 using a Mini-Traction Machine (MTM) (available from PCS Instruments, London, United Kingdom). The MTM was/is operated using a 19.05 mm (¾ inch) diameter ball composed of AISI 52100 bearing steel and a 46 mm diameter disc composed of AISI 52100 bearing steel. The disc was/is held in a bath containing the test lubricant formulation to ensure that the contact area between the ball and the flat surface of the disc was/is fully immersed. The ball shaft was/is aligned with respect to the disc to prevent spin in the contact, and the slide-to-roll ratio (SRR) was/is controlled independently by use of separate motors for both the ball and the disc. The SSR was/is set at 5000, the load was/is set at 1.00 GPa, and the temperature was/is set at 140 °C. The speed of the MTM was/is varied from 0 mm/s to 300 mm/s. The friction coefficient test was/is repeated four times. For the fourth run, twenty data points spaced apart based on a logarithmic scale were/are obtained between 0 mm/s and 80 mm/s. The average of these twenty data points for each formulation was/is reported as the friction coefficient.

Formulations of Inventive Fluid 1 (IF1) and Prophetic Fluids 1-3 (PF1-PF3), and properties of II, are given in Table 2.

TABLE 2

| | IF1 | PF1 | PF2 | PF3 |
|---|---|---|---|---|
| 1-((2-ethylhexyl)oxy)-3- | 82.69 | | | |
| phenoxybenzene, wt % | | | | |
| 1-((n-octyl)oxy)-3- | | 82.69 | | |
| phenoxybenzene, wt % | | | | |
| 1-((n-nonyl)oxy)-3- | | | 82.69 | |
| phenoxybenzene, wt % | | | | |
| 1-((3, 5, 5- | | | | 82.69 |
| trimethylhexyl)oxy)-3- | | | | |
| phenoxybenzene, wt % | | | | |
| Corrosion Inhibitor, wt % | 0.02 | 0.02 | 0.02 | 0.02 |
| Nonionic Detergent, wt % | 0.95 | 0.95 | 0.95 | 0.95 |
| Dispersant, wt % | 1.60 | 1.60 | 1.60 | 1.60 |
| Phenolic Antioxidant, wt % | 1.00 | 1.00 | 1.00 | 1.00 |
| Amine phosphate, wt % | 0.29 | 0.29 | 0.29 | 0.29 |
| Aminic Antioxidant, wt % | 2.80 | 2.80 | 2.80 | 2.80 |
| Pentaerythritol Ester, wt % | 7.00 | 7.00 | 7.00 | 7.00 |
| Other additives, wt % | 3.65 | 3.65 | 3.65 | 3.65 |
| Kinematic Viscosity, | 18.68 | | | |
| ASTM D445, 40° C., cSt | | | | |
| Kinematic Viscosity, | 3.612 | | | |
| ASTM D445, 100° C., cSt | | | | |
| High Temperature High | 1.5 | | | |
| Shear Viscosity, ASTM | | | | |
| D4683, MPa · S | | | | |
| Boron, ASTM D4951, | 0.00763 | | | |
| mass % | | | | |
| Calcium, ASTM D4951, | <0.001 | | | |
| mass % | | | | |
| Magnesium, ASTM | <0.001 | | | |
| D4951, mass % | | | | |
| Molybdenum, ASTM | <0.001 | | | |
| D4951, mass % | | | | |
| Phosphorus, ASTM | 0.0111 | | | |
| D4951, mass % | | | | |
| Zinc, ASTM D4951, | <0.001 | | | |
| mass % | | | | |
| Sulfur, ASTM D6443, | 0.0011 | | | |
| mass % | | | | |
| hpDSC (air), ° C. | 294 | | | |
| Friction Coefficient at | 0.078 | | | |
| 140° C. | | | | |

Inventive Fluid 1 had an oxidation stability, as measured by oxidation onset temperature under hpDSC (air), of 294 °C. Inventive Fluid 1 had a friction coefficient at 140 °C of 0.078.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A compound, having the structure: 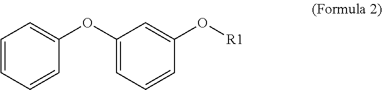
wherein R1 is:

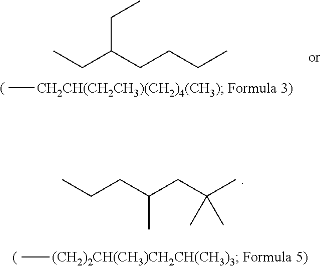

2. The compound of claim 1, which is 1-((2-ethylhexyl)oxy)-3-phenoxybenzene,

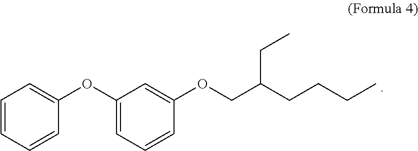 [SMILES: CCCCC(CC)COc1cccc(Oc2ccccc2)c1]

3. The compound of claim 1, which is 1-((3,5,5-trimethylhexyl)oxy)-3-phenoxybenzene,

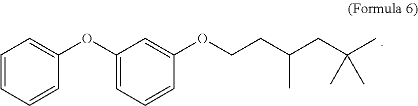 [SMILES: CC(CCOc1cccc(Oc2ccccc2)c1)CC(C)(C)C]

4. A fluid, comprising:
about 15 wt % to about 99 wt % polyphenyl oxide having the structure: 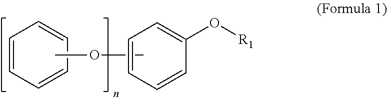
wherein R1 is a linear or branched C8-C12 alkyl group and n is 1 or 2; and
about 1 wt % to about 25 wt % of an additive package.

5. The fluid of claim 4, wherein R1 is:

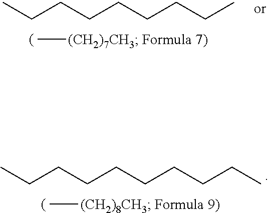

6. The fluid of claim 4, wherein R1 comprises at least one tertiary or quaternary carbon.

7. The fluid of claim 4, wherein R1 is:

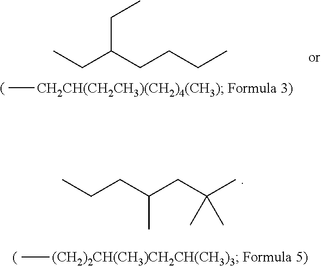

8. The fluid of claim 4, wherein the polyphenyl oxide is a diphenyl oxide having the structure:

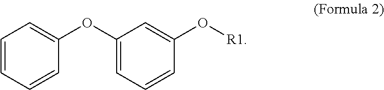

9. The fluid of claim 8, wherein R1 is a linear C8-C12 alkyl group.

10. The fluid of claim 9, wherein R1 is:

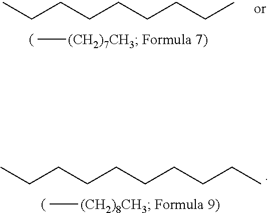

11. The fluid of claim 8, wherein R1 is a branched C8-C12 alkyl group.

12. The fluid of claim 11, wherein the diphenyl oxide has a pour point less than about −65 °C.

13. The fluid of claim 11, wherein the diphenyl oxide has an oxidation onset temperature greater than about 295 °C.

14. The fluid of claim 11, wherein R1 comprises at least one tertiary or quaternary carbon.

15. The fluid of claim 11, wherein R1 is:

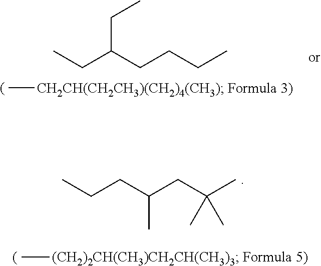

16. The fluid of claim 4, wherein the additive package comprises an additive selected from the group consisting of antioxidants, antiwear agents, antifoaming agents, metal passivators, friction modifiers, pour point improvers, corrosion inhibitors, detergents, dispersants, and any combination thereof.

17. The fluid of claim 4, further comprising about 5 wt % to about 85 wt % Group I/II/III/IV/V oil base stock.

18. The fluid of claim 4, further comprising about 3 wt % to about 10 wt % viscosity improver.

19. The fluid of claim 4, wherein the fluid has a friction coefficient at 140 °C of 0.08 or below as measured by minitraction machine (MTM).

20. A method of lubrication and/or thermal management of a system, comprising:
contacting a surface with a fluid comprising:
about 15 wt % to about 99 wt % polyphenyl oxide having the structure: 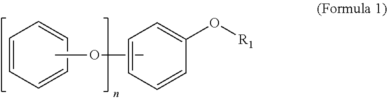
wherein R1 is a linear or branched C8-C12 alkyl group and n is 1 or 2; and
about 1 wt % to about 25 wt % of an additive package.

21. The method of claim 20, wherein the polyphenyl oxide is a diphenyl oxide having the structure:

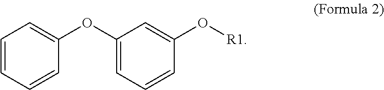

22. The method of claim 20, wherein R1 is:

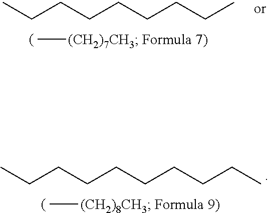

23. The method of claim 20, wherein R1 comprises at least one tertiary or quaternary carbon.

24. The method of claim 20, wherein R1 is:

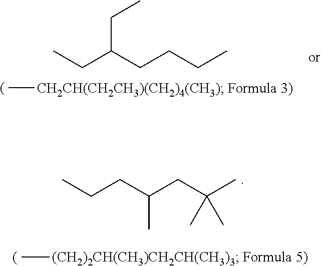

25. The method of claim 20, wherein the surface is a bearing, a gear, at least a portion of an electric motor, a clutch, a gearbox, or any combination thereof.

26. The method of claim 25, wherein the fluid is circulated while contacting the surface.
